(19) United States
(12) Patent Application Publication
(10) Pub. No.: US 2023/0160027 A1
(43) Pub. Date: May 25, 2023

(54) PATTERNED NATURAL LEATHER SHEET, AND METHOD FOR PATTERNING NATURAL LEATHER

(71) Applicant: Pangea Made, Inc., Rochester Hills, MI (US)

(72) Inventors: Naoyuki TANIGUCHI, Tokyo (JP); Yoshiaki SUZUKI, Tokyo (JP); Nathan Douglas STURGEON, Rochester Hills, MI (US)

(21) Appl. No.: 17/773,739

(22) PCT Filed: Oct. 14, 2020
(86) PCT No.: PCT/JP2020/038727

§ 371 Date: Oct. 14, 2022

(30) Foreign Application Priority Data
Oct. 31, 2019 (JP) 2019-198336

(51) Int. Cl. C14B 1/56; C14B 1/30; B60N 2/58

(52) U.S. Cl. CPC C14B 1/56; C14B 1/30; B60N 2/5891

(57) ABSTRACT

To provide with a method wherein a three-dimensional pattern having a clear convex ridgeline is patterned to a natural leather, and a natural leather seat with high design effect having the pattern. A patterned natural leather seat having on the surface one or several patterns having a convex ridgeline; a patterned natural leather seat wherein:
the aforementioned pattern height is 0.5-2.0 mm,
the aforementioned pattern base angle is 0.2°-89°,
and the backside of the leather seat is flat.

### TECHNICAL FIELD

The present invention relates to a natural leather seat wherein a pattern having convex ridgeline is given, and its patterning method.

### BACKGROUND ART

Conventionally, a natural leather wherein embossment is done has been used in many goods including car seats, sofa, bags, wallets and the like. By performing embossment to the natural leather and forming roughness to the surface, it can give suitable decorativeness and feel.

Techniques for embossing the natural leather are roughly classified into a flat plate embossing method and a roll embossing method. As the flat plate embossing method, a method wherein a die is pressed against the leather surface to make it concave (Patent Literature 1), and a method wherein the pattern is raised to the surface by pressing the leather using a male and female die (Patent Literature 2) and the like are known. In the method of Patent Document 1, when the natural leather 1 is pressed shallower than the depth of the die 2, a gap is formed between the leather 1 and the die 2, and the surface of the leather 2 swells round (see FIG. 5A); when the natural leather 3 is pressed deeper than the depth of the die 4, the surface of the leather 3 is crushed by the die 4 and becomes flat (see FIG. 5B). In other words, for the concave portion, sharp lines in the shape of the die can be expressed by the pressure from above, but for the convex portion, sufficient pressure cannot be applied, and sharp lines could not be expressed.

Also, in the method of Patent Literature 2, although it is relatively easy to form a sharp line on the natural leather 5 in the shape of the die 6 in both the concave and convex portions (see FIG. 6A), the bottom of the natural leather 5 was raised to protrude the surface, so the formed pattern was not permanent, and was easily lost by load or friction (see FIG. 6B).

Therefore, as the patterns formed on the natural leather by embossment, there are various patterns including the imitations of reptiles such as alligators, crocodiles, ostriches and the like, and geometrical patterns, botanical patterns, etc., however, the conventional patterns have been all flat and lacked sharpness and three-dimensional appearance (Non-patent literature 1).

### PRECEDING ART DOCUMENT

### Patent Literature

PATENT LITERATURE 1 Publication of Japanese Laid-Open Patent Publication No. Hei 6 (1994)-100900

PATENT LITERATURE 2 Publication of Japanese Laid-Open Patent Publication No. Hei 7 (1995)-138600

NON-PATENT LITERATURE 1 EMBOSS CATALOG, Fall/Winter 2017, SUMIDA KAWASUKI CO., LTD.

The present invention has been done in view of aforementioned problems, and its objectives are to provide with a patterning method wherein a three-dimensional pattern with clear convex ridges is patterned to a natural leather, and a natural leather seat with a high design effect having the pattern.

### Means for Solving the Problem

The present inventors came to complete the present invention as a result of various consideration, finding out that the above issues could be resolved by devising the method of forming the shape and pattern of the die, etc.

In other words, the present invention relates to:
1) a patterned natural leather seat having one or more patterns with convex ridges on the surface,
   a patterned natural leather seat wherein:
   the aforementioned pattern height is 0.5-2.0 mm,
   the aforementioned pattern base angle is 0.2°-89°,
   the backside of the leather seat is flat;
2) the patterned natural leather seat described in (1), wherein the pattern comprises a polygonal pyramid convex part;
3) the patterned natural leather seat described in (2), having a convex ridgeline of 3-100 mm a in the aforementioned polygonal pyramid convex part;
4) the patterned natural leather seat described in any one of (1)-(3), wherein the pattern is a pattern having the concave part on the outer periphery of the convex part;
5) a method of patterning on a natural leather comprising:
   the process of preparing a die having one or several concave parts, a die wherein the aforementioned concave part has a tilt angle of 0.2°-45° and a depth of 0.5-2 mm, and preparing a pressure receiver; the process of installing a natural leather wherein the thickness is 0.5-2.0 mm, in between the aforementioned pressure receiver and the aforementioned die;
   the process of pressing the aforementioned natural leather with the aforementioned die at a pressure of 0.1-5.0 MPa, and applying one or more selected from heat, ultrasonic waves and high frequency;
6) a method described in (5), wherein the pressure receiver comprises a plane metal surface having a hardness of 25-722 and a cushioning material having a thickness of 0.5-20 mm on the aforementioned plane metal surface.
7) the method described (5) or (6), wherein the depth of the die is shallower than the thickness of the natural leather.

### Effects of Invention

According to the present invention, it becomes possible to provide with a natural leather seat with a high design effect, having a three-dimensional pattern with sharp convex ridges.

Also, according to the present invention, it becomes possible to realize a further clarification of the convex portion of the pattern, by having the concave portion on the outer periphery of the convex portion of the pattern formed on the natural leather sheet.

### BRIEF DESCRIPTION OF THE DRAWINGS

FIG. 1A A cross-sectional view of a patterned natural leather seat of the present invention.

FIG. 1B A cross-sectional view of a die used in a patterning method of natural leather of the present invention.

FIG. 2A It is a first embodiment of the patterned natural leather seat of the present invention.

FIG. 2B It is a second embodiment of the patterned natural leather seat of the present invention.

FIG. 2C It is a third embodiment of the patterned natural leather seat of the present invention.

FIG. 2D It is a fourth embodiment of the patterned natural leather seat of the present invention.

FIG. 2E It is a fifth embodiment of the patterned natural leather seat of the present invention.

FIG. 2F It is a sixth embodiment of the patterned natural leather seat of the present invention.

FIG. 3A It is a patterning method of the natural leather pertaining to the Working Example 1 of the present invention.

FIG. 3B It is a surface photo of the patterned natural leather seat pertaining to the Working Example 1 of the present invention.

FIG. 4A It is a patterning method of the natural leather pertaining to the Working Example 1 of the present invention.

FIG. 4B It is a surface photo of the patterned natural leather seat pertaining to the Comparative Example 1 of the present invention.

FIG. 5A It is a figure showing an example of the patterning method of the natural leather of a prior art.

FIG. 5B It is a figure showing an example of the patterning method of the natural leather of a prior art.

FIG. 6A It is a figure showing an example of the patterning method of the natural leather of a prior art.

FIG. 6B It is a figure showing an example of the patterning method of the natural leather of a prior art.

### DESCRIPTION OF EMBODIMENTS

### (Definition)

In the present invention, the term “embossing” refers to a processing method wherein an embossed pattern is created by pressing on a natural leather with a die having an uneven pattern.

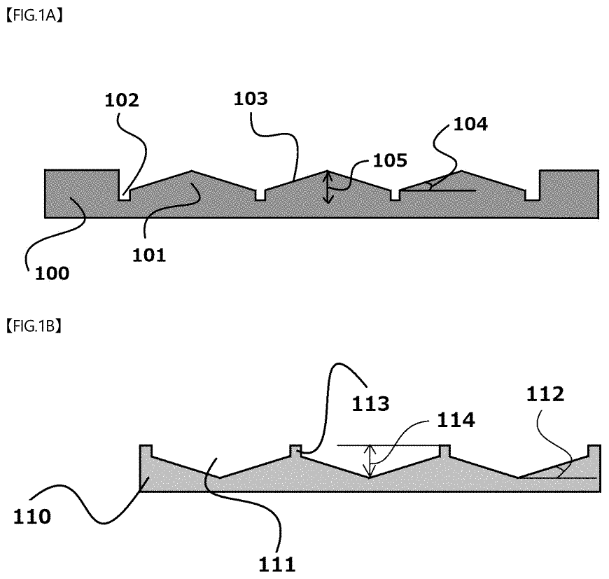

In the present invention, the term “convex ridgeline” refers to a line segment (side) protruding like a mountain ridge formed by two adjacent faces of a pattern formed on a natural leather (See, for example, 103 in FIG. 1A).

In the present invention, the term “pattern base angle” refers to an angle between the horizontal plane of the convex part of the pattern formed on the natural leather and the convex ridgeline in contact with the horizontal plane (See, for example, 104 in FIG. 1A).

In the present invention, the term “pattern height” refers to the maximum height difference of the pattern formed on the natural leather (See, for example, 105 in FIG. 1A). For example, when the pattern formed on the natural leather has only the polygonal pyramid convex part, “pattern height” indicates the distance between the top and the bottom of the polygonal pyramid.

In the present invention, the term “tilt angle” refers to an angle between the horizontal plane and the inclined plane of the die (See, for example, 112 in FIG. 1B).

In the present invention, the term “die depth” refers to the maximum height difference of the die (See, for example, 114 in FIG. 1B).

In the present invention, “natural leather” includes but is not limited to those originated from mammalian including cows, horses, pigs, goats, sheep, deer, kangaroos; birds including ostriches; reptiles including snakes and crocodiles. Especially, cowhide of large area with high versatility is preferred. The biological leather collection site to become the source of the natural leather is not especially limited. The leather is made by tanning the dermis of raw hides. As a method of tanning, Wet white, Wet blue and the combination of the two are used.

### (Patterned Natural Leather Seat)

The patterned natural leather seat 100 of the present invention is illustrated in FIG. 1A, and has one or more patterns having convex ridgeline on the surface.

The pattern height 105 is 0.5-2 mm, is preferably 0.75-1.75 mm, is particularly preferably 1.0-1.5 mm. When the pattern height 105 is less than 0.5 mm, it does not become a three-dimensional pattern; when the pattern height 105 exceeds 2 mm, the convex ridgeline cannot be formed.

The pattern base angle 104 is 0.2°-89°, is preferably 0.5°-60°, is particularly preferably 1°-45°. When the pattern base angle 104 is less than 0.2°, it does not become a three-dimensional pattern; when the pattern base angle 104 exceeds 89°, the convex ridgeline 103 cannot be formed.

Although not limited to this, the pattern of the natural leather seat may have the concave part 102 on the outer periphery of the convex part 101. With the above, the boundary of the convex part 101 becomes clear, and a pattern with sharp impression can be formed. The depth of the concave part 102 is preferably 0.01-1.0 mm, more preferably 0.03-0.5 mm, particularly preferably 0.05-0.1 mm. When the depth of the concave part is within the range, it is easier to further clarify the convex part.

The pattern shape is not particularly limited, but the examples thereof include a polygonal pyramid, a polygonal frustum, a truncated cone, and a shape obtained by deforming the top of the above, and the like.

“Polygonal pyramid” is a pyramid wherein the shape of the bottom surface is a polygon, and all sides are triangular. In the present invention, “polygonal pyramid” is not particularly limited, but is preferably from a triangular pyramid to a decagonal pyramid, more preferably a triangular pyramid to a hexagonal pyramid, and particularly preferably a triangular pyramid or a quadrangular pyramid. A pyramid wherein the bottom surface is a n-gon is called a n-gonal pyramid.

“Polygonal frustum” is a three-dimensional figure obtained by removing a polygonal pyramid that share vertices and are similarly reduced from a polygonal pyramid. In the present invention, the “polygonal frustum” is not particularly limited, but is preferably from a triangular frustum to a decagonal frustum, more preferably from a triangular frustum to a hexagonal frustum, and particularly preferably a triangular frustum or a square frustum. Note that a truncated pyramid wherein the bottom surface is an n-gon is called an n-gonal frustum.

“Circular truncated cone” is a frustum with a circle as the base, and a three-dimensional figure excluding the small circular cone part by cutting the cone with a plane parallel to the bottom surface.

### The First Embodiment

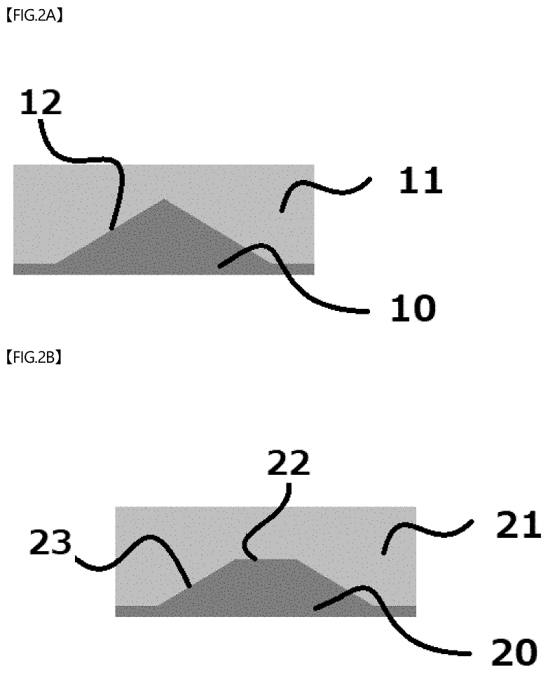

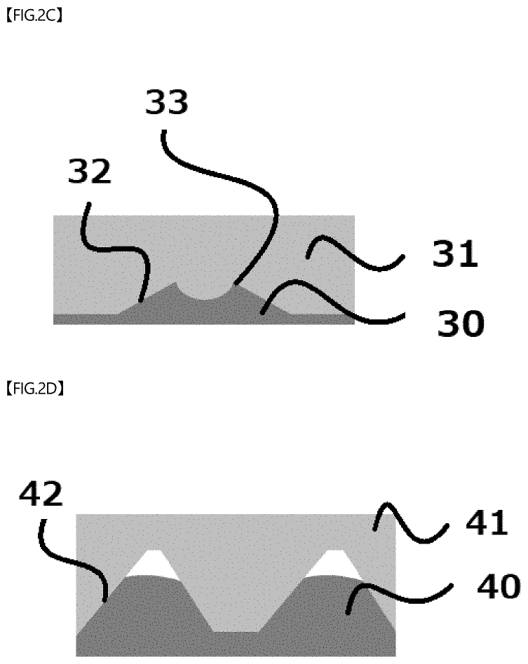

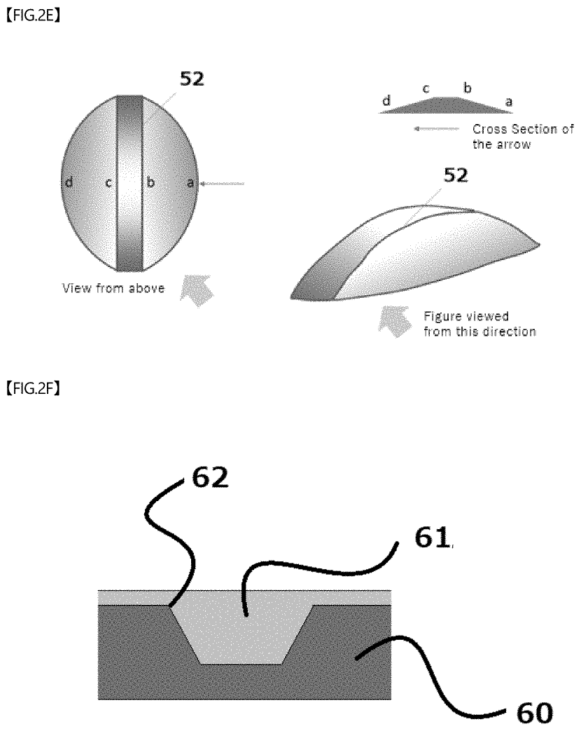

FIG. 2A shows the first embodiment of the patterned natural leather seat of the present invention. In the present embodiment, the pattern formed on a natural leather seat 10 has a polygonal pyramid convex part. In this embodiment, a clear convex ridgeline 12 can be formed on the side surface of the polygonal pyramid. In this embodiment, the length of the convex ridgeline 12 is preferably 3-100 mm, is more preferably 10-80 mm, and particularly preferably 20-50 mm. If the length of the convex ridgeline is less than 3 mm, it is difficult to confirm a clear convex ridgeline, and it is difficult to form a convex ridgeline exceeding 100 mm. The length of one side of the bottom surface of the polygonal pyramid is preferably 2.0-70 mm, is more preferably 5.0-50 mm, and is particularly preferably 10-40 mm. If the length of one side is less than 2.0 mm, it may be difficult to confirm a sharp convex ridgeline, and if it exceeds 70 mm, it may be difficult to form a three-dimensional pattern.

### The Second Embodiment

FIG. 2B shows the second embodiment of the patterned natural leather seat of the present invention. In the present embodiment, the pattern formed on a natural leather seat 20 has a polygonal frustum convex part or a truncated cone convex part. In this embodiment, a clear convex ridgeline 22 can be formed on the upper surface of the polygonal frustum or the circular truncated cone. Also, in a case of polygonal frustum convex part, a clear ridgeline 23 can be formed not only on the upper surface but also on the side surface of the polygonal frustum. In this embodiment, the length of one side of the bottom surface of the polygonal frustum is preferably 2.0-70 mm, is more preferably 5.0-50 mm, and particularly preferably 10-40 mm. If the length of one side is less than 2.0 mm, it is difficult to confirm a clear convex ridgeline, and if it exceeds 70 mm, it may be difficult to form a three-dimensional pattern. The length of the diameter of the bottom surface of the circular truncated cone is preferably 2.5-100 mm, is more preferably 7.0-75 mm, and is particularly preferably 15-60 mm. If the length of one side is less than 2.5 mm, it may be difficult to confirm a sharp convex ridgeline, and if it exceeds 100 mm, it may be difficult to form a three-dimensional pattern.

### The Third Embodiment

FIG. 2C shows the third embodiment of the patterned natural leather seat of the present invention. In the present embodiment, the pattern formed on a natural leather seat 30 has a convex part wherein the top of the polygonal pyramid is depressed. In this embodiment, by modifying the die shape, it is possible to create a curved shape having a convex ridgeline 32 formed on the side surface, and a convex ridgeline 33 on the upper surface. In this embodiment, the length of one side of the bottom surface is preferably 2.0-70 mm, is more preferably 5.0-50 mm, and is particularly preferably 10-40 mm. If the length of one side is less than 2.0 mm, it is difficult to confirm a clear convex ridgeline, and if it exceeds 70 mm, it may be difficult to form a three-dimensional pattern.

### The Fourth Embodiment

FIG. 2D shows the fourth embodiment of the patterned natural leather seat of the present invention. In the present embodiment, the pattern formed on a natural leather seat 40 has a convex part wherein the top of the polygonal pyramid is naturally curled up. In this embodiment, by performing embossment by not letting the surface of the natural leather 40 touch the deep part of the die, it is possible to form a convex ridgeline 42 on the side surface, also to leave a natural texture of the natural leather on the top of the convex part. In this embodiment, the length of one side of the bottom surface is preferably 2.0-70 mm, is more preferably 5.0-50 mm, and is particularly preferably 10-40 mm. If the length of one side is less than 2.0 mm, it is difficult to confirm a clear convex ridgeline, and if it exceeds 70 mm, it may be difficult to form a three-dimensional pattern.

### The Fifth Embodiment

In the present embodiment, a pattern formed on a natural leather seat 10 is shown in FIG. 2E. In this embodiment, it is possible to form a clear convex ridgeline 52 on the upper surface. In this embodiment, the length of the convex ridgeline is preferably 2.0-70 mm, is more preferably 5.0-50 mm, and is particularly preferably 10-40 mm. When the length of the convex ridgeline is less than 2.0 mm, it is difficult to confirm a clear convex ridgeline, and it is difficult to form a convex ridgeline exceeding 70 mm.

### The Sixth Embodiment

FIG. 2F shows the sixth embodiment of the patterned natural leather seat of the present invention. In the present embodiment, the pattern formed on a natural leather seat 60 has a polygonal frustum concave part. In this embodiment, it is possible to form a clear convex ridgeline 62 on the upper surface. Thus, even if it has only a concave part, as long as it has a convex ridgeline, it is equivalent to the pattern in the present invention.

As the backside of the patterned natural leather seat of the present invention is flat, the formed pattern does not easily disappear due to load or friction.

### (Patterning Method of Natural Leather)

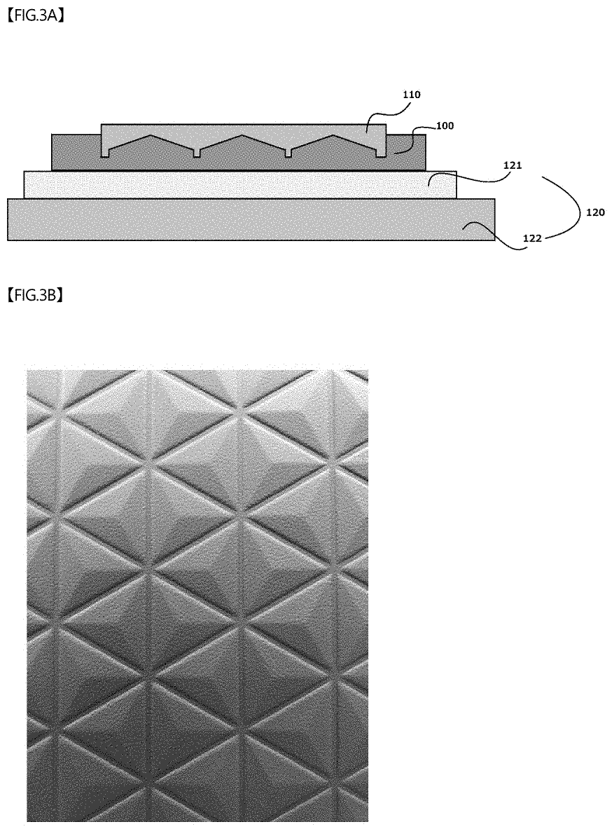

As shown in FIG. 3A, the embossing method of a natural leather of the present invention is a method wherein a natural leather 100 is installed and pressed between a die 110 and a pressure receiver 120, and by adding one or more selected from heat, ultrasonic waves and high frequency waves, a pattern of the die 110 is formed on the surface of the natural leather 100.

The die used in the patterning method of the present invention is exemplified in FIG. 1B. As shown in FIG. 1B, the die 110 has one or more concave part 111. The tilt angle 112 of the concave part 111 is 0.2°-89°, is preferably 0.5°-60°, and is particularly preferably 1°-45°. If the tilt angle 112 of the concave part 111 of the die 110 is less than 0.2°, a three-dimensional pattern cannot be obtained, and if it exceeds 89°, a convex ridgeline cannot be formed.

The depth 114 of the die 110 is 0.5-2 mm, is preferably 0.75-1.75 cm, and is particularly preferably 1.0-1.5 cm. If the depth 114 is less than 0.5 mm, a three-dimensional pattern is not formed, and if it exceeds 2 mm, a convex ridgeline cannot be formed. However, this does not apply to the case wherein the surface of the natural leather does not touch the deep part of the die as in the aforementioned fourth embodiment.

Although not limited to this, the outer periphery of the concave part 111 of the die 110 may have a convex part 113. By having the convex part 113, a pattern of clear and sharp impression can be formed by the natural leather. The height of the convex part 113 is preferably 0.01-1 mm, is more preferably 0.03-0.5 cm, and is particularly preferably 0.05-0.1 cm. When the height of the convex part is within the range, the pattern can be further clarified.

If desired, the surface of the die 110 can be blasted to form fine concavity and convexity (scratches) on the surface of the die. As a result, not only can the light on the natural leather surface be pressed by the die be irregularly reflected to give a high-quality appearance, but also improvements on the functional aspects such as the touch or dirt prevention can be expected.

The pressure receiver 120 is preferably, but not limited to, a plane metal surface 122 having a hardness of 25 to 722 and a cushioning material 121 on the plane metal surface. More preferably, the cushioning material 121 is a wool felt having a thickness of 0.5 to 20 mm. By using the pressure receiver 120 having the above-described constitution, it becomes easier to secure a design property wherein a clear convex ridgeline is expressed even in a three-dimensional shape having a pattern height of 0.5-2.0 mm.

The thickness of the natural leather is preferably 0.5-2.0 mm, is more preferably 0.7-1.5 mm, and is particularly preferably 0.8-1.2 mm. When the thickness of the natural leather exceeds the above range or is less than the above range, a clear convex ridgeline may not be formed.

In the present invention, the thickness of the natural leather is determined by measuring the thickness of ten points on the cross section and taking the mean value.

In the present invention, the depth of the die is preferably shallower than the thickness of the natural leather. By making the die shape wherein there is no gap between the natural leather and the die, the shape according to the die can be given to the surface of the natural leather. However, it is not limited to the above in a case wherein the die is purposefully deepened in order to round the convex top of the natural leather pattern, as in the aforementioned fourth embodiment. In addition, on the back surface of the natural leather, a backing material may be pasted with an adhesive in advance or simultaneously with the present method. When the hardness of the backing material is lower than the hardness of the natural leather (for example, urethane foam), the depth of the die is still shallower than the thickness of the natural leather. On the other hand, when the hardness of the backing material is close to or higher than that of the genuine leather, and is made of a thermoplastic material (for example, vinyl chloride), the objective can be similarly achieved when the depth of the die is shallower than the thickness determined by adding the natural leather and the backing material.

The pressure at the time of pressing is 0.1-5.0 MPa, is preferably 0.3-4.0 MPa, and is more preferably 0.4-3.0 MPa. When the pressure is within the above range, a clear convex ridgeline is likely to be formed.

As the backside of the patterned natural leather seat of the present invention is flat, the formed pattern does not easily disappear due to load or friction.

### WORKING EXAMPLES

The present invention will be described in more detail with reference to a working example, but the present invention is not limited to only the working example. In the following working example, % indicates % by mass.

### Working Example 1

On a metal table 122, a wool felt 121 having a thickness of 3.0 mm was placed, and a natural leather 100 having a thickness of 2.0 mm was placed. On the surface of the natural leather 100, embossment was performed by pressing (pressure 2 MPa) a 25 cm square iron die 110 for patterning while heating (die surface temperature 100° C.) (see FIG. 3A).

The embossed natural leather pattern has a triangular pyramid convex part (height: 1.5 mm) and a concave part (depth: 0.1 mm) on its outer periphery; the concavity and convexity form, and convex ridgeline were clearly formed (pattern height: 1.6 mm) (see FIG. 3B).

In addition, a car seat was created using a patterned natural leather seat as the surface material, and a 8000-times durability test (at 23° C. and 50% RH) was performed using a seat getting-on-and-off durability tester manufactured by TM TEC. Even in the seat after the durability test, the concavity and convexity form, and convex ridgeline clearly remained.

### Comparative Example 1

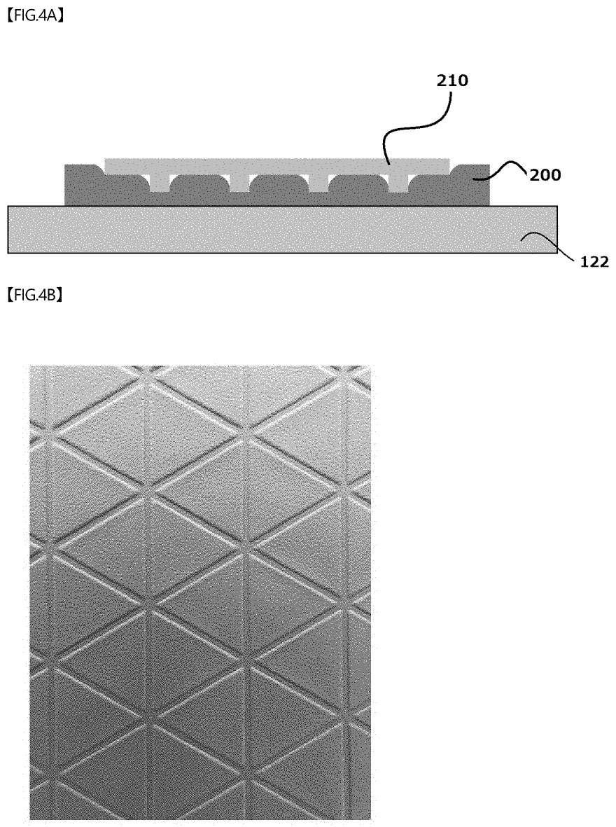

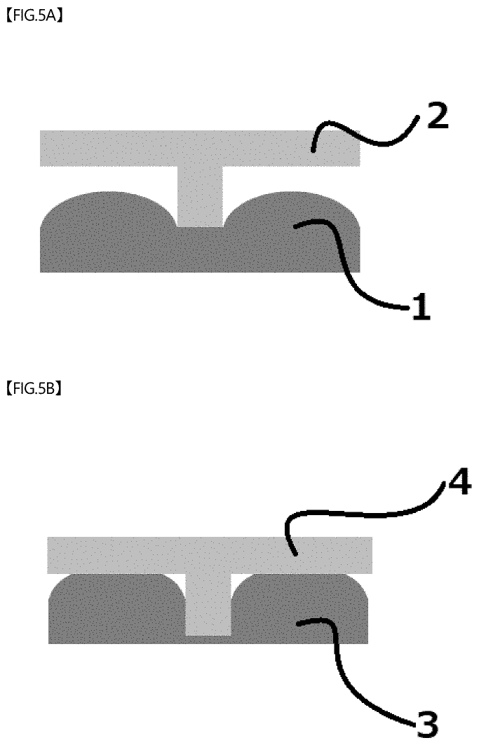

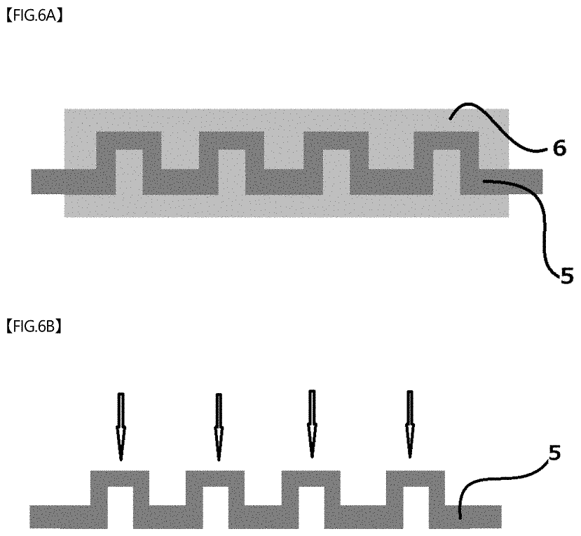

On a metal table 122, a natural leather 200 of the thickness of 2.0 mm was placed. On the surface of the natural leather 200, embossment was performed by pressing (pressure 2 MPa) a 25 cm square iron die 210 for patterning while heating (die surface temperature 100° C.) (see FIG. 4A).

The embossed natural leather pattern is a flat triangle expressed by a concave part having the depth of 0.1 mm, had no sharpness, and had a poor three-dimensional appearance (see FIG. 4B).

### INDUSTRIAL APPLICABILITY

The patterned natural leather seat of the present invention can be used as interior materials and seats for railway vehicles, automobiles, aircrafts, ships, and the like, industrial materials, interior materials, clothing, clothing materials, and the like.

### EXPLANATION OF REFERENCES

1, 3, 5, 10, 20, 30, 40, 60, 100, 200 Natural Leather

11, 21, 31, 41, 61, 110 Patterning die of the present invention

2, 4, 6, 210 Conventional patterning die

101 Convex part of the pattern

102 Concave part of the pattern

12, 22, 23, 32, 33, 42, 52, 62, 103 Convex ridgeline

104 Pattern base angle

105 Pattern height

111 Concave part of the die

112 Tilt angle of the die

113 Convex part of the die

114 Die depth

120 Pressure receiver

121 Cushioning material

122 Plane metal surface

1. A patterned natural leather seat having on the surface one or several patterns having a convex ridgeline;
a patterned natural leather seat wherein:
the aforementioned pattern height is 0.5-2.0 mm,
the aforementioned pattern base angle is 0.2°-89°, and
the backside of the leather seat is flat.

2. A patterned natural leather seat of claim 1 wherein the pattern comprises a polygonal pyramid convex part.

3. The aforementioned polygonal pyramid convex part is the patterned natural leather seat of claim 2 having a convex ridgeline of 3-100 mm.

4. A patterned natural leather seat of any one of claims 1-3 wherein the pattern is a pattern having a concave part on the outer periphery of the convex part.

5. A method of patterning on a natural leather comprising:
the process of preparing a die having one or several concave parts, a die wherein the aforementioned concave part has a tilt angle of 0.2°-45° and a depth of 0.5-2 mm, and preparing a pressure receiver;
the process of installing a natural leather wherein the thickness is 0.5-2.0 mm, in between the aforementioned pressure receiver and the aforementioned die;
the process of pressing the aforementioned natural leather with the aforementioned die at a pressure of 0.1-5.0 MPa, and applying one or more selected from heat, ultrasonic waves and high frequency.

6. A method of claim 5 wherein the pressure receiver comprises a plane metal surface having a hardness of 25 to 722, and a cushioning material having a thickness of 0.5 to 20 mm on the aforementioned plane metal surface.

7. A method of claim 5 or 6 wherein the depth of the aforementioned die is shallower than the thickness of the natural leather.
